(19) United States
(12) Patent Application Publication
(10) Pub. No.: US 2022/0007706 A1
(43) Pub. Date: Jan. 13, 2022

(54) GENERATION OF AN INHALABLE MEDIUM

(71) Applicant: NICOVENTURES TRADING LIMITED, London (GB)

(72) Inventors: David BISHOP, London (GB); Anna STOCHAJ, London (GB); Matthew HOWARD, London (GB)

(21) Appl. No.: 17/293,839

(22) PCT Filed: Nov. 4, 2019
(86) PCT No.: PCT/EP2019/080126

§ 371 Date: May 13, 2021

(30) Foreign Application Priority Data
Nov. 13, 2018 (GB) 1818458.0

(51) Int. Cl. A24B 15/167; A24F 40/42; A24F 40/10; A24F 40/20; A24F 40/30

(52) U.S. Cl. CPC A24B 15/167; A24F 40/42; A24F 40/30; A24F 40/20; A24F 40/10

(57) ABSTRACT

A composition for use in generating an inhalable medium, the composition comprising an extruded material, wherein the extruded material comprises a flavorant and no tobacco-derived components.

### PRIORITY CLAIM

The present application is a National Phase entry of PCT Application No. PCT/EP2019/080126, filed Nov. 4, 2019 which claims priority from GB Patent Application No. 1818458.0 filed Nov. 13, 2018, each of which is hereby fully incorporated herein by reference.

### TECHNICAL FIELD

The present disclosure relates, without limitation, to a composition for use in generating an inhalable medium, a method of preparing the said composition, an aerosol generating article, an aerosol generating assembly, an aerosol generating device and a kit, all of which incorporate the said composition.

### BACKGROUND

Smoking articles such as cigarettes, cigars and the like burn tobacco during use to create tobacco smoke. Alternatives to these types of articles, release compounds without burning to form an inhalable medium.

One example of such a product is a heating device is a heat not burn product, which releases compounds by heating, but not burning, a solid material. This solid aerosolizable material may, in some cases, contain a tobacco material. The heating volatilizes at least one component of the material, typically forming an inhalable aerosol. These products may be referred to as heat-not-burn devices, tobacco heating devices or tobacco heating products. Various different arrangements for volatilizing at least one component of the solid aerosolizable material are known.

As another example, there are e-cigarette/tobacco heating product hybrid devices, also known simply as hybrid devices. Hybrid devices contain a liquid which is vaporized by heating to produce an inhalable vapor or aerosol. The liquid may contain flavorings and/or aerosol-generating substances, such as glycerol and in some instances, nicotine. The vapor or aerosol passes through material in the device and entrains one or more constituents of a substrate material to produce the inhaled medium. The substrate material may be, for example, tobacco, other non-tobacco products or a combination, such as a blended mix, which may or may not contain nicotine.

### SUMMARY

In some embodiments described herein, the disclosure provides a composition for use in generating an inhalable medium, the composition comprising an extruded material, wherein the extruded material comprises a flavorant and no tobacco-derived components.

The composition may be used to generate the inhalable medium, or may be used to contribute components of the inhalable medium to an existing aerosol or vapor (i.e. the aerosol or vapor may entrain the flavorant and/or other components of the composition). That is the composition may be used alone to generate the inhalable medium, or it may be used in conjunction with an auxiliary source of an aerosol generating agent.

The disclosure also provides an aerosol generating article, the article comprising a composition, the composition comprising an extruded material, wherein the extruded material comprises a flavorant and no tobacco-derived components; and wherein the article is configured to generate an inhalable medium as the composition is heated without burning. The disclosure also provides an aerosol generating assembly comprising the said article and a heater which is configured to heat, but not burn, the composition.

Throughout this specification, reference to heating the composition may comprise direct heating of the composition, or indirect heating. An example of indirect heating is heating that results from the passage of a heated vapor/aerosol through or near to the composition.

The disclosure also provides an aerosol generating device for generating an inhalable medium, the device comprising:

a container for holding a liquid;

a heater for volatilizing liquid held in the container;

a chamber containing a solid composition; and

an outlet;

wherein the solid composition comprises an extruded material, wherein the extruded material comprises a flavorant and no tobacco-derived components.

and wherein the device is configured such that in use, an inhalable medium passes out of the outlet, the medium comprising (i) volatilized liquid in the form of a vapor and/or an aerosol and (ii) one or more constituents of the composition retained in the chamber.

The disclosure also provides a method of preparing a composition,

wherein the composition comprises an extruded material, the extruded material comprising a flavorant and no tobacco-derived components,

wherein the method comprises the formation of a mixture including the flavorant, extruding the mixture and drying the mixture to form the extruded material.

The disclosure also provides a kit comprising;

(i) a liquid pod containing a volatilizable liquid; and

(ii) a solid composition pod, containing a composition comprising an extruded material, the extruded material comprising a flavorant and no tobacco-derived components;

wherein the liquid and solid composition pod are configured for use in a device for use in generating an inhalable medium, the device being such that in use, an inhalable medium is generated, the medium comprising (i) volatilized liquid from the liquid pod in the form of a vapor and/or an aerosol and (ii) one or more constituents of the composition in the solid composition pod.

To the extent that they are compatible, features described in relation to one aspect of the disclosure are explicitly disclosed in combination with each and every other aspect. For instance, features described in relation to the composition, article, assembly device, method or kit are explicitly disclosed in combination with the each of the others of the composition, article, assembly device, method and kit.

Further features and advantages of the disclosure will become apparent from the following description of preferred embodiments of the disclosure, given by way of example only, which is made with reference to the accompanying drawings.

### BRIEF DESCRIPTION OF THE DRAWINGS

Examples of embodiments according to the disclosure are described below with reference to the accompanying drawings, in which:

FIG. 1 shows a schematic longitudinal cross-sectional view of an example of a device for generating an inhalable medium;

FIG. 2 shows a schematic longitudinal cross-sectional view of another example of a device for generating an inhalable medium;

FIG. 3 shows a schematic longitudinal cross-sectional view of another example of a device for generating an inhalable medium;

FIG. 4 shows a schematic longitudinal cross-sectional view of an example of a cartridge having a liquid container and an integral container for solid material; and.

FIG. 5 shows a schematic longitudinal cross-sectional view of an example of a cartridge having a liquid container and a detachable container for solid material.

### DETAILED DESCRIPTION

As used herein, the terms “flavor”, “flavorant” and “flavoring” refer to materials which, where local regulations permit, may be used to create a desired taste or aroma in a product for adult consumers. They may include extracts (e.g., liquorice, hydrangea, Japanese white bark magnolia leaf, chamomile, fenugreek, clove, menthol, Japanese mint, aniseed, cinnamon, herb, wintergreen, cherry, berry, peach, apple, Drambuie, bourbon, scotch, whiskey, spearmint, peppermint, lavender, cardamom, celery, cascarilla, nutmeg, sandalwood, bergamot, geranium, honey essence, rose oil, vanilla, lemon oil, orange oil, cassia, caraway, cognac, jasmine, ylang-ylang, sage, fennel, piment, ginger, anise, coriander, coffee, or a mint oil from any species of the genus Mentha), flavor enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, oil, liquid, or powder.

In some cases, the flavorant may be a botanical flavorant. That is, the flavorant may be a plant-derived flavor. In some cases, the botanical flavorant may be included in the extruded material in solid form. That is, in these cases, the botanical flavorant is not in the form of a liquid extract. In some cases, the flavorant may be selected from the cardamom pod, cinnamon stick, lavender, sage, lemon myrtle, clove, eucalyptus and ginger.

In some cases, the extruded material comprises from about 40 wt % to about 90 wt % of flavorant, calculated based on the total weight of the extruded material.

The extruded material may, in some cases, include one or more of a wetting agent, a binder and a bulking agent.

In some cases, the extruded material comprises from about 5 wt % to about 35 wt % of a wetting agent, calculated based on the total weight of the extruded material. In some cases the wetting agent may comprise water. In some cases, the wetting agent may comprise an aerosol generating agent. As used herein, “aerosol generating agent” refers to a compound or mixture that promotes the generation of an aerosol. An aerosol generating agent may promote the generation of an aerosol by promoting an initial vaporization and/or the condensation of a gas to an inhalable solid and/or liquid aerosol. In general, any suitable aerosol generating agent or agents may be included in the aerosol generating material of the disclosure. Suitable aerosol generating agents include, but are not limited to: a polyol such as sorbitol, glycerol, and glycols like propylene glycol or triethylene glycol; a non-polyol such as monohydric alcohols, high boiling point hydrocarbons, acids such as lactic acid, glycerol derivatives, esters such as diacetin, triacetin, triethylene glycol diacetate, triethyl citrate or myristates including ethyl myristate and isopropyl myristate and aliphatic carboxylic acid esters such as methyl stearate, dimethyl dodecanedioate and dimethyl tetradecanedioate. In some cases, the wetting agent may be selected from glycerol, water and propylene glycol. In some cases, the wetting agent may comprise further flavors. For example, the wetting agent may comprise rose water.

In some cases, the extruded material comprises up to about 10 wt % of a binder, calculated based on the total weight of the extruded material. In some cases, the binder comprises one or more of an alginate, celluloses or modified celluloses, starches or modified starches, and natural gums. Suitable binders include, but are not limited to: carrageenan, alginate salts comprising any suitable cation, such as sodium alginate, calcium alginate, and potassium alginate; celluloses or modified celluloses, such as hydroxypropyl cellulose and carboxymethylcellulose; starches or modified starches; pectin salts comprising any suitable cation, such as sodium pectate; xanthan gum, guar gum, locust bean gum and any other suitable natural gums. In some cases, the binder may comprise carboxymethylcellulose, starch, locust bean gum, guar gum or carrageenan gum.

In some cases, the extruded material may comprise one or more bulking agents. When present, the bulking agent is inert (i.e. does not contribute any components of the aerosol) and serves to lower the flavor intensity delivered in the inhalable medium. Suitable bulking agents include calcium carbonate (i.e. chalk), perlite, vermiculite, diatomaceous earth, colloidal silica, magnesium oxide, magnesium sulphate, magnesium carbonate, and suitable inorganic sorbents, such as molecular sieves. In some cases, the extruded material comprises no bulking agent.

In some cases, the extruded material may comprise one or more activation agents. When present, the activation agents serve to increase the volatility of the flavorant. Suitable activation agents may include bases and acids, for example sodium bicarbonate.

In some cases, the extruded material is in the form of granules, and the composition comprises a plurality of the said granules. In some cases, the average particle size of the granules is in the range of about 0.4 mm to about 3.5 mm. Suitably, the average particle size of the granules is in the range of about 0.7 mm to about 2.0 mm. (As used herein, the “average particle size” refers to the size of the minimum particle dimension.)

In some cases, the granules are of a generally cylindrical shape with a diameter of approximately 1.3 mm. The granules may be formed using a circular die hole (diameter 1.3 mm) and face cutter (a spinning blade that cuts the extrudate to a specified length as it comes out of the die). The speed of the face cutter controls the size of the granules. In some cases, the face cutter speed may be set so that the cylinders have a length of approximately 1.3 mm. There may be some expansion of the granules over time, and the cylindrical shape may be lost due to fragmentation in processing/handling.

In some cases, the extruded material has a density in the range of about 0.4 gcm⁻³ to about 1.5 gcm⁻³.

The extruded material comprises no tobacco-derived components. In some cases, the composition comprises no tobacco-derived components. In some other cases, the composition additionally comprises tobacco-derived components. For instance, the composition may comprise a second extruded material that comprises tobacco. In some cases where there are two extruded materials, the two materials are in the form of granules which are mixed to form the composition. In some cases, the two extruded materials have a similar density (e.g. ±0.2 gcm⁻³, suitably ±0.1 gcm⁻³) to minimize separation of the mixed granules. In other cases where there are two extruded materials, the two materials may have different densities, to effect separation of the two populations; this may result in a layer-like arrangement, which is useful when it is desirable for one component to be arranged upstream of the other, for example. In some cases the granules may be layered with one of the two extruded materials being deposited in a container prior to the other of the two extruded materials. In yet further cases, there may be two extruded materials which are provided in separate chambers, which are arranged in series in the flow path.

The tobacco-derived components may, in some cases, be provided by any suitable tobacco material. The tobacco-derived components may comprise nicotine. As used herein, “tobacco material”, refers to any material comprising tobacco or derivatives thereof. The term “tobacco material” may include one or more of tobacco, tobacco derivatives, expanded tobacco, reconstituted tobacco or tobacco substitutes. The tobacco material may comprise one or more of ground tobacco, tobacco fiber, cut tobacco, extruded tobacco, tobacco stem, reconstituted tobacco, agglomerated tobacco, sphereonized tobacco and/or tobacco extract. Such tobacco materials may be extruded to form the second extruded composition.

The tobacco used to produce tobacco material may be any suitable tobacco, such as single grades or blends, cut rag or whole leaf, including Virginia and/or Burley and/or Oriental. It may also be tobacco particle ‘fines’ or dust, expanded tobacco, stems, expanded stems, and other processed stem materials, such as cut rolled stems. The tobacco material may be a ground tobacco or a reconstituted tobacco material. The reconstituted tobacco material may comprise tobacco fibers, and may be formed by casting, or by a Fourdrinier-based paper making-type approach with back addition of tobacco extract.

In some cases, the extruded material comprises no tobacco-derivable components. That is, the material comprises no synthetic materials which are derivable from tobacco. In some cases, the extruded material comprises no nicotine.

In some cases, the extruded material may be porous, such that an aerosol or vapor can pass through the material. Thus, components of the composition are efficiently entrained in the aerosol/vapor in use.

The disclosure also provides an aerosol generating article, the article comprising a composition, the composition comprising an extruded material, wherein the extruded material comprises a flavorant and no tobacco-derived components. The article may, in some cases, be configured to generate an inhalable medium as the composition is heated without burning. The article may, in some cases, be configured to pass a heated vapor and/or an aerosol through the composition, thereby entraining the vapor and/or aerosol with at least the flavorant.

In some cases, the article may be configured for use an in an aerosol provision device. The article may, in some cases, be configured for use with a heat-not-burn device. In such devices, the composition is heated without burning. The heating may be an electrically resistive heater, an induction heater or the like, or may be a combustible heat source or a chemical heat source which undergoes an exothermic reaction to product heat in use.

The article may, in some cases, be configured for use with a hybrid device or the like. In some cases, the article is a cartridge for use in a device for generating an inhalable medium, the cartridge comprising a volatilizable liquid in a container, and a composition in a separate chamber, wherein the composition comprises an extruded material, wherein the extruded material comprises a flavorant and no tobacco-derived components.

The article may, in some cases, be configured for use in other types of aerosol provision systems, such as e-cigarettes or inhalers.

The disclosure also provides an aerosol generating assembly comprising the said article and a heater which is configured to heat, without burning, the composition. The assembly may be a heat-not-burn device. The assembly may be a hybrid device.

The disclosure also provides an aerosol generating device for generating an inhalable medium, the device comprising:

a container for holding a liquid;

a heater for volatilizing liquid held in the container;

a chamber containing a solid composition; and

an outlet;

wherein the solid composition comprises an extruded material, wherein the extruded material comprises a flavorant and no tobacco-derived components.

and wherein the device is configured such that in use, an inhalable medium passes out of the outlet, the medium comprising (i) volatilized liquid in the form of a vapor and/or an aerosol and (ii) one or more constituents of the composition retained in the chamber.

The device comprises a container for holding a volatilizable liquid. In some cases, the device comprises a container which is holding a volatilizable liquid. Suitable liquids include those conventionally used in e-cigarette devices. In some cases, the volatilizable liquid may comprise nicotine and/or a tobacco extract and/or flavorings and/or aerosol-generating agents, such as propylene glycol and/or glycerol. The liquid is typically volatilized at around 150-250° C.

The device according to some examples of the disclosure may be configured such that in use, liquid volatilized by the heater passes, in the form of at least one of a vapor and an aerosol, through the chamber to thereby entrain one or more constituents from the composition to produce the inhalable medium which passes out of the outlet.

In other examples, the flow path from the liquid container may be combined with a separate flow path which runs from the composition so as to form the inhalable medium. In other words, in some example devices, the volatilized liquid does not pass through the chamber retaining the composition.

In some cases, the device comprises means for heating the composition to volatize components of the composition and form a first aerosol and/or vapor. The liquid may be volatilized to form a second vapor and/or aerosol, which may be combined with the first vapor and/or aerosol to form the inhalable medium. In some cases, one heater may heat both the liquid and the composition. In some cases, the device may be configured such that the heater only heats the liquid composition directly and the composition is heated by warmth carried in the vapor/aerosol formed from the volatilized liquid (thereby volatilizing components of the composition which are then entrained in the vapor/aerosol flow).

In an embodiment, the device comprises a cooler or cooling zone downstream of the heater and upstream of the chamber, the cooler or cooling zone being arranged to cool vaporized liquid to form an aerosol of liquid droplets which in use passes through the composition in the chamber. The cooler may be arranged in effect to act as a heat exchanger, allowing for recovery of heat from the vapor. The recovered heat can be used for example to pre-heat the composition and/or to assist in heating the liquid.

In an embodiment, the device comprises a second heater for heating the composition in the chamber. This enables the composition to be heated by the heater, which encourages release of compounds from the composition, and optionally allows a lower temperature to be used for the heated liquid.

In an embodiment, the device is battery-operated.

In an embodiment, the or each heater is an electrically resistive heater.

In an embodiment, the liquid container is removable. The liquid container may be in the form of a pot or the like (which in some embodiments may be annular for example), and/or an absorbent wadding or the like. The whole liquid container containing the liquid may in effect be a disposable item which is replaced as a whole after use. As an alternative, the arrangement may be such that the user removes the liquid container from the device, replaces used liquid or tops up liquid in the container, and then places the container back in the device.

In some cases, the liquid container may be non-removable from the device. In such an embodiment, the user may just replace used liquid or top up liquid in the container after use as necessary.

In some cases, the liquid container and the chamber are an integral unit. In some cases, the integral unit is a cartridge that can be removed from the device.

In some cases, the chamber is removable from the device. The chamber may be, for example, in the form of a cartridge or the like which contains the composition before use. The whole chamber containing the composition may in effect be a disposable item which is replaced as a whole after use. As an alternative, the arrangement may be such that the user removes the chamber from the device, replaces used material in the chamber, and then places the chamber back in the device.

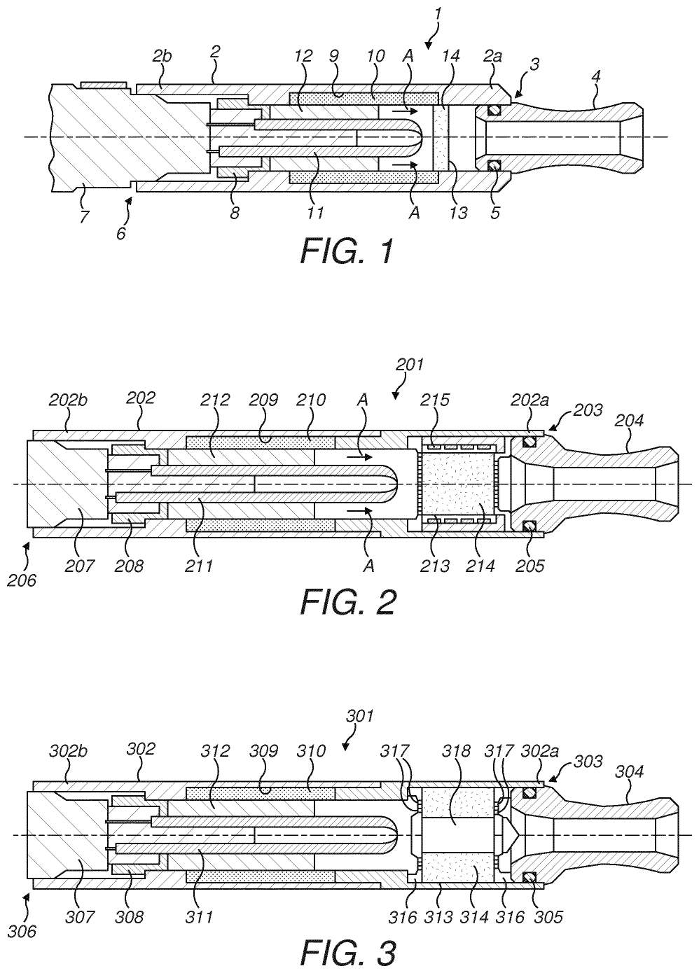

Examples of devices for generating an inhalable medium according to the some embodiments of the disclosure will now be described, with reference to the accompanying drawings. Referring to FIG. 1, there is shown an example of a device 1 for generating an inhalable medium. In broad outline, the device 1 volatilizes a liquid to form a vapor or an aerosol which passes through a material so as to produce an inhalable medium that contains one or more constituents derived from the material.

In this respect, first it may be noted that, in general, a vapor is a substance in the gas phase at a temperature lower than its critical temperature, which means that for example the vapor can be condensed to a liquid by increasing its pressure without reducing the temperature. On the other hand, in general, an aerosol is a colloid of fine solid particles or liquid droplets, in air or another gas. A “colloid” is a substance in which microscopically dispersed insoluble particles are suspended throughout another substance.

Returning to FIG. 1, the device 1 of this example has a generally hollow cylindrical outer housing 2. The housing 2 has an open end 3. In this example, a tubular mouthpiece 4 is provided in the open end 3. The mouthpiece 4 in this example is removable by a user from the housing 2. An O-ring or other seal 5 assists in sealing the mouthpiece 4 in the housing 2. At or towards the other end 6 of the housing 2 is a battery 7 for powering various components of the device 1, as will be discussed further below. The battery 7 may be a rechargeable battery or a disposable battery. A controller 8 is also provided in the housing 2 for controlling the operation of various components of the device 1, as will be discussed further below.

The housing 2 has a container 9 for holding or containing a liquid 10. Various different forms for the container 9 may be used. In the example of FIG. 1, the container 9 is in the form of an annular chamber 9 provided in the housing 2 between the open end 3 and the other end 6. In this particular example, the housing 2 is in two parts, a first part 2a being towards the open end 3 and a second part 2b towards the other end 6. The first and second parts 2a, 2b of the housing 2 may connect to each other via a screw thread, a bayonet fitting or the like. In use, a user can separate the first and second parts 2a, 2b of the housing 2 to allow the liquid 10 to be replenished or replaced as necessary. Alternatively, the mouthpiece 4 can be removed to provide access to the container 9. It will be understood however that other arrangements are possible. For example, the liquid 10 may be provided in a discrete annular pot-like container which can be removed as a whole from the housing 2. Such a discrete container may be disposable so that the user replaces the liquid 10 by fitting a new container with liquid 10 in the housing 2. Alternatively, such a container may be reusable. In such a case, the user may replenish or replace liquid 10 in the container whilst it has been removed from the housing 2 and then replace the refilled container in the housing 2. It will be understood that the housing 2 need not be in two parts and that other arrangements enabling access for the user may be provided, for example, to enable refilling in situ.

A heater 11 is provided generally centrally of the housing 2, that is, centrally along the length and width of the housing 2 in this example. In this example, the heater 11 is powered by the battery 7 and is therefore electrically connected to the battery 7. The heater 11 may be an electrically resistive heater, including for example a nichrome resistive heater, a ceramic heater, etc. The heater 11 may be for example a wire, which may for example be in the form of a coil, a plate (which may be a multi-layer plate of two or more different materials, one or more of which may be electrically conductive and one or more of which may be electrically non-conductive), a mesh (which may be woven or non-woven for example, and which again may be similarly multi-layer), a film heater, etc. Other heating arrangements may be used, including non-electrical heating arrangements.

This heater 11 is provided for volatilizing the liquid 10. In the example shown, an annular wick 12 surrounds the heater 11 and is in (thermal) contact with the heater 11. The outermost surface of the annular wick 12 is in contact with liquid 10 contained in the liquid container 9. The wick 12 is generally absorbent and acts to draw in liquid 10 from the liquid container 9 by capillary action. The wick 12 is preferably non-woven and may be for example a cotton or wool material or the like, or a synthetic material, including for example polyester, nylon, viscose, polypropylene or the like. Whilst this will be described more fully below, it may be noted here that in use, liquid 10 drawn into the wick 12 is heated by the heater 11. The liquid 10 may be volatilized so as to produce an aerosol of liquid droplets or sufficiently heated to produce a vapor. The aerosol or vapor so produced exits the wick 12 and passes towards the mouthpiece 4 as shown by the arrows A under the action of the user drawing on the mouthpiece 4. The heater 11 and wick 12 may be provided as a single, effectively integral item, sometimes referred to as an “atomizer”, such that the heating and wicking is effectively carried out by a single unit.

The housing 2 further contains a chamber 13 which holds or contains a composition 14 in the device 1. The composition 14 comprises an extruded material that itself comprises a flavorant and no tobacco-derived components. In some cases, the flavorant is a solid botanical flavor. The composition may, in some cases, include a second extruded material that comprises tobacco material. In some cases, the composition may comprise a plurality of granules that may be a mixture of the two extruded materials, each of which is in granular form.

In use, a user can access the chamber 13 to replace or replenish the composition 14 through the open end 3 of the housing 2 by removing the mouthpiece 4 and/or by separating the two parts 2a, 2b of the housing 2. Various different forms for the chamber 13 may be used. For example, the chamber 13 may be a tube which is completely open at both ends and which contains the composition 14. As another example, the chamber 13 may be a tube which has one or more end walls which have through holes through which a vapor or aerosol can pass. The chamber 13 may remain in situ within the housing 2 whilst the user removes and replaces the composition 14. Alternatively, the chamber 13 containing the composition 14 may be a discrete item which in use is inserted into and removed from the housing 2 as a whole. A removable chamber 13 of this type may be disposable so that the user replaces the composition 14 by fitting a new chamber 13 containing fresh composition 14 into the housing 2. As an alternative, the chamber 13 may be reusable. In such a case, the user may replace the composition 14 in the chamber 13 whilst the chamber 13 has been removed from the housing 2 and then replace the refilled chamber 13 in the housing 2. In yet another example, the chamber 13 may comprise clips or the like provided internally of the housing 2 and which retain the composition 14 in position. In some examples, the composition 14 could simply fit snugly within the chamber 13. As another alternative, the container 9 for containing the liquid 10 may itself be arranged to support or carry the composition 14. For example, the container 9 may have one or more clips or a tube or the like for receiving and holding the composition 14 in position. Such a dual function container 9/chamber or receptacle 13 for both containing the liquid 10 and receiving the composition 14 may be in the form of a cartridge or the like and may be a disposable item or may be re-useable, with the liquid 10 and composition 14 being replaced or topped up by the user as required. In some cases, it may be that the user only needs to top up or replace the composition 14 from time to time, with sufficient liquid 10 being provided for several uses. Once the liquid 10 has been consumed, the user disposes of the dual function container 9/receptacle 13 and uses a new one. Likewise, it may be that the user only needs to top up or replace the liquid 10 from time to time, with sufficient composition 14 being provided for several uses. Once the composition 14 has been consumed, the user disposes of the dual function container 9/receptacle 13 and uses a new one. Specific examples of dual function containers/receptacles are discussed further below.

The composition 14 is located in the housing 2 downstream of the location where the aerosol or vapor is produced from the liquid 10 and upstream of the open end 3 of the housing 2 and the mouthpiece 4. In this particular example, the composition 14 is effectively provided in the same portion or chamber of the housing 2 as the wick 12. The aerosol or vapor produced from the liquid 10 exits the wick 12 and passes as shown by the arrows A towards the composition 14 under the action of the user drawing on the mouthpiece 4. In particular embodiments, the composition 14 is porous so that the aerosol or vapor passes through the composition 14 and then through the open end 3 of the housing 2 and the mouthpiece 4.

In some embodiments, the composition 14 and/or its chamber 13 are arranged so that there is no air gap between the composition 14/chamber 13 and the interior of the housing 2 so that the aerosol or vapor flows entirely through the composition 14.

The liquid 10 is suitably a liquid that is volatilizable at reasonable temperatures, preferably in the range of 100-300° C. or more particularly around 150-250° C., as that helps to keen down the power consumption of the device 1. Suitable materials include those conventionally used in e-cigarette devices, including for example propylene glycol and glycerol (also known as glycerine).

The composition 14 imparts a flavor to the aerosol or vapor produced from the liquid 10 as the aerosol or vapor passes through the composition 14. As the aerosol or vapor passes through and over the composition 14, the hot aerosol or vapor entrains organic and other compounds or constituents that have organoleptic properties from the composition 14, thus imparting the flavor to the aerosol or vapor as it passes to the mouthpiece 4.

The device 1 may provide nicotine for the user. The nicotine may be provided in the liquid 10, may be obtained from the composition 14, or a combination of these. Likewise, flavorings may be added to the liquid 10.

In the example shown in FIG. 1, the only heat source for heating the composition 14 in the device 1, which is required so as to generate the organic and other compounds or constituents from the composition 14, is the hot aerosol or vapor produced from heating the liquid 10.

Referring now to FIG. 2, there is shown another example of a device for generating an inhalable medium. In the following description and in FIG. 2, components and features that are the same as or similar to the corresponding components and features of the example described with reference to FIG. 1 have the same reference numeral but increased by 200. For the sake of brevity, the description of those components and features will not be repeated in its entirety here. It will be understood that the arrangements and alternatives, etc. described above in relation to the example of FIG. 1 are also applicable to the example of FIG. 2. Again, in broad outline, the device 201 of FIG. 2 heats a liquid to form a vapor or an aerosol which passes through a composition 214 so as to produce an inhalable medium that contains one or more constituents derived from the composition 214.

The device 201 of this example has a generally hollow cylindrical outer housing 202 with an open end 203 and a tubular mouthpiece 204. The mouthpiece 204 in this example is removable by a user from the housing 202 and an O-ring or other seal 205 assists in sealing the mouthpiece 204 in the housing 202. A battery 207 for powering various components of the device 201 and a controller 208 are provided at or towards the other end 206 of the housing 202. The housing 202 of this example is in two parts, a first part 202a being towards the open end 203 and a second part 202b towards the other end 206.

The housing 202 has a container 209 for holding or containing a liquid 210. The container 209 may be of any of the types described above in relation to the example of FIG. 1. A heater 211 is provided generally centrally (lengthwise and widthwise) of the housing 202 for volatilizing the liquid 210. In this example, the heater 211 is powered by the battery 207 and is therefore electrically connected to the battery 207. The heater 211 may be an electrically resistive heater, a ceramic heater, etc. The heater 211 may be for example a wire, which may for example be in the form of a coil, a plate (which may be a multi-layer plate of two or more different materials, one or more of which may be electrically conductive and one or more of which may be electrically non-conductive), a mesh (which may be woven or non-woven for example, and which again may be similarly multi-layer), a film heater, etc. Other heating arrangements may be used, including inductive heating arrangements or non-electrical heating arrangements. An annular wick 212 surrounds the heater 211 and is in (thermal) contact with the heater 211. The outermost surface of the annular wick 212 is in contact with liquid 210 contained in the liquid container 209. The liquid 210 may be heated so as to produce an aerosol of liquid droplets or sufficiently heated to produce a vapor. The aerosol or vapor so produced exits the wick 212 and passes towards the mouthpiece 204 as shown by the arrows A under the action of the user drawing on the mouthpiece 204. The heater 211 and wick 212 may be provided as a single, effectively integral item such that the heating and wicking is effectively carried out by a single unit.

The housing 202 further contains a chamber 213 which holds or contains a composition 214 in the device 201. The composition 214 may be any of the types described above in relation to FIG. 1. The chamber 213 may be of any of the types described above in relation to the example of FIG. 1. The composition 214 is located in the housing 202 downstream of the location where the aerosol or vapor is produced from the liquid 210 and upstream of the open end 203 of the housing 202 and the mouthpiece 204. In this particular example, the composition 214 is effectively provided in the same portion or chamber of the housing 202 as the wick 212. The aerosol or vapor produced from the liquid 210 exits the wick 212 and passes as shown by the arrows A towards the composition 214 under the action of the user drawing on the mouthpiece 204. In particular embodiments, the composition 214 is porous so that the aerosol or vapor passes through the composition 214 and then through the open end 203 of the housing 202 and the mouthpiece 204.

In some embodiments, the composition 214 and/or its chamber 213 are arranged so that there is no air gap between the composition 214/chamber 213 and the interior of the housing 202 so that the aerosol or vapor flows entirely through the composition 214. As the aerosol or vapor passes through and over the composition 214, the hot aerosol or vapor entrains organic and other compounds or constituents that have organoleptic properties from the composition 214, thus imparting the flavour to the aerosol or vapor as is passes to the mouthpiece 204.

The container 209 for containing the liquid 210 may itself be arranged to support or carry the composition 214. For example, the container 209 may have one or more clips or a tube or the like for receiving and holding the composition 214 in position. Such a dual function container 209/chamber or receptacle 213 for both containing the liquid 210 and receiving the composition 214 may be in the form of a cartridge or the like and may be a disposable item or may be re-useable, with the liquid 210 and composition 214 being replaced or topped up by the user as required. In some cases, it may be that the user only needs to top up or replace the composition 214 from time to time, with sufficient liquid 210 being provided for several uses. Once the liquid 210 has been consumed, the user disposes of the dual function container 209/receptacle 213 and uses a new one. Likewise, it may be that the user only needs to top up or replace the liquid 210 from time to time, with sufficient composition 214 being provided for several uses. Once the composition 214 has been consumed, the user disposes of the dual function container 209/receptacle 213 and uses a new one.

In the example device 201 of FIG. 2, a second heater 215, such as an oven heater, is provided in thermal contact with the composition 214 to pre-heat the composition 214 and/or provide additional heat to the composition 214 throughout use of the device 201. This encourages release of constituents from the composition 214 as the vapor or aerosol passes through the composition 214 in use. The amount of heated liquid 210 to achieve desirable heating of the composition 214 may be reduced. The second heater 215 may be an electrically resistive heater, a ceramic heater, etc., powered by for example the battery 207. The second heater 215 may be for example a wire, which may for example be in the form of a coil, a plate (which may be a multi-layer plate of two or more different materials, one or more of which may be electrically conductive and one or more of which may be electrically non-conductive), a mesh (which may be woven or non-woven for example, and which again may be similarly multi-layer), a film heater, etc. The second heater 215 may be an inductive heater powered by for example the battery 207. The composition 214 may include materials susceptible to inductive heating. Other heating arrangements may be used for the second heater 215, including non-electrical heating arrangements.

In the example device 201 of FIG. 2, the heater 215 for heating the composition 214 is provided externally of the composition 214 and heats the composition 214 by heat conduction from the exterior of the composition 214. The heater 215 in this example is generally cylindrical. The heater 215 may in effect be an integral part of the device 201 and be provided as part of the housing 202. As an alternative, the heater 215 may be provided integrally with the chamber 213 which holds or contains the composition 214. In this alternative, in the case that the chamber 213 is disposable, the heater 215 will be replaced when a new chamber 213 with fresh material is loaded into the device 201 by the user.

Referring now to FIG. 3, there is shown another example of a device for generating an inhalable medium. In the following description and in FIG. 3, components and features that are the same as or similar to the corresponding components and features of the example described with reference to FIG. 1 have the same reference numeral but increased by 300. For the sake of brevity, the description of those components and features will not be repeated in its entirety here. It will be understood that the arrangements and alternatives, etc. described above in relation to the examples of FIG. 1 and FIG. 2 are also applicable to the example of FIG. 3. Again, in broad outline, the device 301 of FIG. 3 heats a liquid to form a vapor or an aerosol which passes through a composition 314 so as to produce an inhalable medium that contains one or more constituents derived from the composition 314.

The device 301 of this example again has a generally hollow cylindrical outer housing 302 with an open end 303 and a tubular mouthpiece 304, which is removable by a user from the housing 302. O-ring or other seal 305 assists in sealing the mouthpiece 304 in the housing 302. A battery 307 for powering various components of the device 301 and a controller 308 are provided at or towards the other end 306 of the housing 302. The housing 302 of this example is again in two parts, a first part 302a being towards the open end 303 and a second part 302b towards the other end 306.

The housing 302 has a container 309 for holding or containing a liquid 310. The container 309 may be of any of the types described above in relation to the examples of FIGS. 1 and 2. A heater 311 is provided generally centrally of the housing 302 for heating the liquid 310. The heater 311 may be any of the types described above. In this example, the heater 311 is powered by the battery 307 and is therefore electrically connected to the battery 307. An annular wick 312 surrounds the heater 311 and is in (thermal) contact with the heater 311. The outermost surface of the annular wick 312 is in contact with liquid 310 contained in the liquid container 309. The liquid 310 may be heated so as to produce an aerosol of liquid droplets or sufficiently heated to produce a vapor. The aerosol or vapor so produced exits the wick 312 and passes towards the mouthpiece 304 as shown by the arrows A under the action of the user drawing on the mouthpiece 304. The heater 311 and wick 312 may be provided as a single, effectively integral item such that the heating and wicking is effectively carried out by a single unit.

The housing 302 further contains a chamber 313 which holds or contains a composition 314 in the device 301. The composition 314 may be any of the types described above in relation to FIG. 1 or FIG. 2. The chamber 313 may be of any of the types described above in relation to the examples of FIGS. 1 and 2. (In the example shown in FIG. 3, the chamber 313 is in the form of a tube which has end walls 316 which have through holes 317 through which a vapor or aerosol can pass, which was mentioned as an option above.) The composition 314 is located in the housing 302 downstream of the location where the aerosol or vapor is produced from the liquid 310 and upstream of the open end 303 of the housing 302 and the mouthpiece 304. In this particular example, again, the composition 314 is effectively provided in the same portion or chamber of the housing 302 as the wick 312. The aerosol or vapor produced from the liquid 310 exits the wick 312 and passes as shown by the arrows A towards the composition 314 under the action of the user drawing on the mouthpiece 304. In particular embodiments, the composition 314 is porous so that the aerosol or vapor passes through the composition 314 and then through the open end 303 of the housing 302 and the mouthpiece 304.

In some embodiments, the composition 314 and/or its chamber 313 are arranged so that there is no air gap between the composition 314/chamber 313 and the interior of the housing 302 so that the aerosol or vapor flows entirely through the composition 314. As the aerosol or vapor passes through and over the composition 314, the hot aerosol or vapor entrains organic and other compounds or constituents that have organoleptic properties from the composition 314, thus imparting flavor to the aerosol or vapor as is passes to the mouthpiece 304. The container 309 for containing the liquid 310 may itself be arranged to support or carry the composition 314. For example, the container 309 may have one or more clips or a tube or the like for receiving and holding the composition 314 in position. Such a dual function container 309/chamber or receptacle 313 for both containing the liquid 310 and receiving the composition 314 may be in the form of a cartridge or the like and may be a disposable item or may be re-useable, with the liquid 310 and composition 314 being replaced or topped up by the user as required. In some cases, it may be that the user only needs to top up or replace the composition 314 from time to time, with sufficient liquid 310 being provided for several uses. Once the liquid 310 has been consumed, the user disposes of the dual function container 309/receptacle 313 and uses a new one. Likewise, it may be that the user only needs to top up or replace the liquid 310 from time to time, with sufficient composition 314 being provided for several uses. Once the composition 314 has been consumed, the user disposes of the dual function container 309/receptacle 313 and uses a new one.

In the example device 301 of FIG. 3, a second heater 318 is again provided in thermal contact with the composition 314 to heat the composition 314 to encourage release of constituents from the composition 314 as the vapor or aerosol passes through the composition 314 in use. The second heater 318 may be an electrically resistive heater, a ceramic heater, etc., powered by for example the battery 307. Other heating arrangements may be used for the second heater 318, including non-electrical heating arrangements.

In the example device 301 of FIG. 3, the heater 318 for heating the composition 314 is provided internally of the composition 314 and heats the composition 314 by heat conduction from the interior of the composition 314. The heater 318 in this example is generally in the form of a cylindrical rod located along the central longitudinal axis of the composition 314. In other arrangements, the heater 318 may be a wire, which may for example be in the form of a coil, a plate (which may be a multi-layer plate of two or more different materials, one or more of which may be electrically conductive and one or more of which may be electrically non-conductive), a mesh (which may be woven or non-woven for example, and which again may be similarly multi-layer), a film heater, etc. The composition 314 in this case is generally tubular or otherwise has an internal aperture for receiving the heater 318. The heater 318 may in effect be an integral part of the device 301 and be provided as part of the housing 302. In this case, as the composition 314 is loaded into the device 301 (for example, as the chamber 313 containing the composition 314 is loaded into the device 301), the composition 314 surrounds the second heater 318. As an alternative, the heater 318 may be provided integrally with the chamber 313 which holds or contains the composition 314. In this alternative, in the case that the chamber 313 is disposable, the heater 318 will be replaced when a new chamber 313 with fresh material is loaded into the device 301 by the user.

In another example, plural internal heaters 318 may be provided, so as to provide for more efficient heating of the composition 314. In another example, the composition 314 may be heated by both one and more external heaters (like the second heater 215 of the example of FIG. 2) and by one or more internal heaters (like the second heater 318 of the example of FIG. 3).

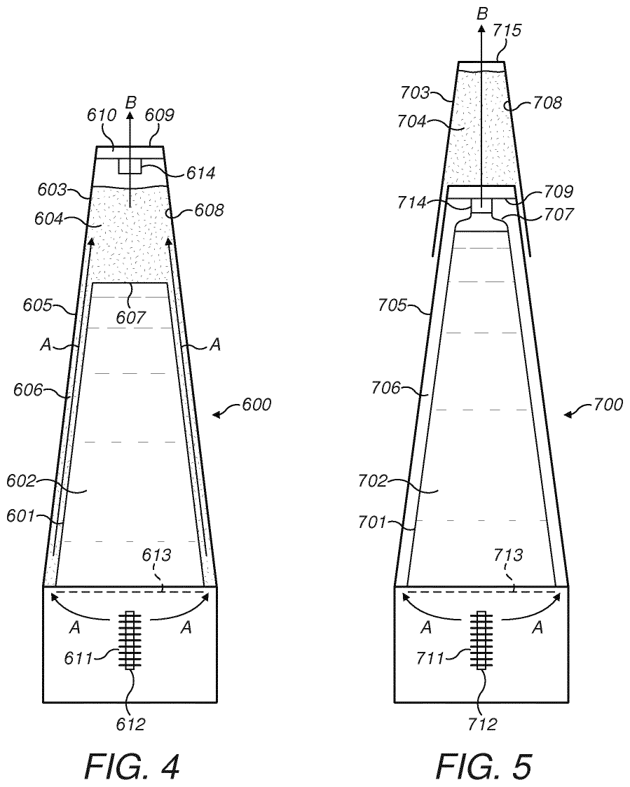

Referring now to FIG. 4, there is shown a schematic longitudinal cross-sectional view of an example of a cartridge 600 having a liquid container 601 for containing liquid 602 and a receptacle or container 603 for composition 604. In this example, the liquid container 601 and the composition container 603 are provided as one integral component, either by being formed integrally initially or being formed initially of two parts which are then assembled in a substantially permanent fashion. The cartridge 600 is arranged so that as the liquid 602 is volatilized so as to produce an aerosol of liquid droplets or sufficiently heated to produce a vapor, at least some and preferably all or substantially all of the aerosol or vapor passes through the composition 604 to pick up flavor from the composition 604.

In the example of FIG. 4, the liquid container 601 is provided generally centrally of the cartridge 600. The liquid container 601 in the example shown is frustoconical in shape, but may have a different shape, such as conical, cylindrical, etc. The liquid container 601 is surrounded by an outer shell 605 which defines an annular channel 606 around the outside of the length of the liquid container 601 and which extends from one end of the liquid container 601 to the other. The outer shell 605 extends beyond a first end wall 607 of the liquid container 601 to define a chamber 608 beyond the first end wall 607 of the liquid container 601. In the example shown, both the chamber 608 and the annular channel 606 contain the composition 604 and so can be regarded as together providing the container 603 for the composition 604. In other examples, the composition 604 may be provided only in the chamber 608, which therefore defines the container 603 for the composition 604, and the annular channel 606 is empty. The chamber 608 is closed off by an end wall 609 which is spaced from the end wall 607 of the liquid container 601. The end wall 609 may be part of the outer shell 605 or may be a separate plastics or rubber cap or the like. In yet other examples, the annular channel 606 contains the composition 604 and there is no material in the chamber 608, and indeed the chamber 608 may be omitted and the channel 606 effectively terminates at the end wall 609. The channel 606 and/or chamber 608 may be entirely filled with composition 604 or may only contain a portion or plug of composition 604. The end wall 609 is porous and/or has one or more through holes 610 to enable the aerosol or vapor to exit the cartridge 600 to be inhaled by a user. The liquid container 601 and the solid container 603 may each be formed of rigid, watertight and airtight materials, such as metal, suitable plastics, etc.

The example cartridge 600 shown in FIG. 4 is provided with a heater 611 and a wick 612 in (thermal) contact with the heater 611. In this example, the heater 611 and the wick 612 are provided as a single unit, often referred to as an “atomizer”. In this case, where the cartridge 600 includes an atomizer, such a cartridge is often referred to as a “cartomizer”. The orientation of the heater 611 is shown schematically and for example the heater 611 may be a coil having its longitudinal axis perpendicular to the longitudinal axis of the cartridge 600 rather than parallel as shown in FIG. 4.

The wick 612 is in contact with the liquid 602. This may be achieved by for example the wick 612 being inserted through a through hole (not shown) in the second end wall 613 of the liquid container 601. Alternatively or additionally, the second end wall 613 may be a porous member (shown schematically in FIG. 4 by dashed lines) which allows liquid to pass through from the liquid container 601, and the wick 612 may be in contact with the porous second end wall 613. The second end wall 613 may be for example in the form of a porous ceramic disk. A porous second end wall 613 of this type helps to regulate the flow of liquid onto the wick 612. The wick 612 is generally absorbent and acts to draw in liquid 602 from the liquid container 601 by capillary action. The wick 612 is preferably non-woven and may be for example a cotton or wool material or the like, or a synthetic material, including for example polyester, nylon, viscose, polypropylene or the like.

In use, the cartridge 600 is connected by the user to a battery section of a device (atomizer shown) to enable the heater 611 to be powered. When the heater 611 of the atomizer is powered (which may be instigated for example by the user operating a button of the overall device or by a puff detector of the overall device, as is known per se), liquid 602 drawn in from the liquid container 601 by the wick 612 is heated by the heater 611 to volatilize or vaporize the liquid. As the user draws on a mouthpiece of the overall device, the vapor or aerosol passes into the annular channel 606 around the outside of the length of the liquid container 601 and into the chamber 608 as shown by the arrows A. The vapor or aerosol picks up flavor from the composition 604. The vapor or aerosol can then exit the cartridge 600 through the end wall 609 as shown by the arrow B. Optionally, a one way valve 614 may be provided inside the end wall 609 so that the vapor or aerosol can only exit the cartridge 600 and cannot back-flow to the heater 611 or the electronics of the device as a whole.

Referring now to FIG. 5, there is shown a schematic longitudinal cross-sectional view of another example of a cartridge 700 having a liquid container 701 for containing liquid 702 and a container 703 which defines a chamber 708 for containing composition 704. In the following description and in FIG. 5, components and features that are the same as or similar to the corresponding components and features of the example described with reference to FIG. 4 have the same reference numeral but increased by 100. For the sake of brevity, the description of those components and features will not be repeated in its entirety here.

In this example, the liquid container 701 and the composition container 703 of the cartridge 700 are provided as separate components, which are detachably connected to each other in use. The liquid container 701 and the composition container 703 may for example be clipped or otherwise detachably fixed to each other, or for example the composition container 703 may simply rest on or be a tight friction fit on the liquid container 701. The cartridge 700 is arranged so that as the liquid 702 is volatilized so as to produce an aerosol of liquid droplets or sufficiently heated to produce a vapor, at least some and preferably all or substantially all of the aerosol or vapor passes through the composition 704 to pick up flavor from the composition 704.

In this example, the liquid container 701 is surrounded by an outer shell 705 which defines an annular channel 706 around the outside of the length of the liquid container 701 and which extends from one end of the liquid container 701 to the other. The outer shell 705 extends beyond a first end wall 707 of the liquid container 601 and terminates in an end wall 709. The end wall 709 may be a separate plastics or rubber cap or the like. The end wall 709 is porous and/or has one or more through holes 710 to enable the aerosol or vapor to exit the annular channel 706. A one way valve 714 may be provided inside the end wall 709 so that the vapor or aerosol can only exit the annular channel 706 at the end remote from the heater 711 and wick 712 and cannot back-flow to the heater 711 or the electronics of the device as a whole. The composition container 703 is located in use over the end wall 709 so that vapor or aerosol exiting through the end wall 709 passed into the composition container 703. The composition container 703 has an exit aperture and/or or a porous end wall 715 to enable the aerosol or vapor to exit the cartridge 700 to be inhaled by a user.

In use, the cartridge 700 is connected by the user to a battery section of a device (not shown) to enable the heater 711 to be powered. When the heater 711 of the atomizer is powered (which may be instigated for example by the user operating a button of the overall device or by a puff detector of the overall device as is known per se), liquid 702 drawn in from the liquid container 701 through the end wall 713 by the wick 712 is heated by the heater 711 to volatilize or vaporize the liquid. As the user draws on a mouthpiece of the overall device, the vapor or aerosol passes into the annular channel 706 around the outside of the length of the liquid container 701 towards the end wall 709 of the outer shell 705 as shown by the arrows A. The vapor or aerosol then passes through the end wall 709 (via the one-way valve 714 if present) and into the composition container 703 where it picks up flavor from the composition 704 contained in the container 703. The vapor or aerosol can then exit the cartridge 700 through the end wall 715 of the composition container 703 as shown by the arrow B.

The examples shown in FIGS. 4 and 5 are particularly suitable for use with so-called modular or “e-go” products, in which the cartomizer is fitted to a battery section (not shown), typically by a screw thread, a bayonet fitting or the like. The cartomizer as a whole is typically discarded after use and a new, replacement cartomizer used. As an alternative, it may be possible for the user to re-use the cartridge by refilling the liquid and/or replacing the solid material from time to time as necessary.

The examples shown in FIGS. 4 and 5 may easily be adapted for use with other types of hybrid device, which are known per se. There are for example so-called “look alike e-cigarette” or “cig-alike” devices which are generally small and have a form and appearance similar to a conventional cigarette. In such devices, the liquid container typically includes some wadding material, of for example cotton or the like, for holding the liquid. The cartridge or cartomizer in such known devices is typically disposable as a whole, but it may be possible to refill the liquid and/or replace the sold material in examples that use an embodiment of the present disclosure. As another example, there are so-called tank devices or personal vaporizers which generally have large liquid containers for holding relatively large volumes of liquid and also provide for advanced functions that allow users to control a number of aspects of the device.

As an alternative to any of the cartomizer arrangements discussed above, the atomizer (i.e. the heater and the wick) for the liquid may be provided separately of the liquid and material containers. The atomizer may for example be provided as part of the battery section of the overall device to which the cartridge is detachably fitted by the user in use.

In any of the examples described above in relation to FIGS. 4 and 5, there may also be provided a heater for the composition so as to “pre-heat” it. This heater may be provided as part of the cartridge or as part of the battery section of the device to which the cartridge is fitted in use.

For the avoidance of doubt, where in this specification the term “comprises” is used in defining the invention or features of the invention, embodiments are also disclosed in which the invention or feature can be defined using the terms “consists essentially of” or “consists of” in place of “comprises”.

The above embodiments are to be understood as illustrative examples of the disclosure. Further embodiments of the disclosure are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

1. A composition for use in generating an inhalable medium, the composition comprising an extruded material, wherein the extruded material comprises a flavorant and no tobacco-derived components.

2. A composition according to claim 1, wherein the flavorant comprises a botanical flavour.

3. A composition according to claim 2, wherein the flavorant is selected from cardamom pod, cinnamon stick, lavender, sage, lemon myrtle, clove, eucalyptus and ginger.

4. A composition according to claim 1, wherein the extruded material comprises from about 40 wt % to about 90 wt % of the flavorant, calculated based on the total weight of the extruded material.

5. A composition according to claim 1, further comprising one or more of a wetting agent, a binder and a bulking agent.

6. A composition according to claim 1, wherein the extruded material is in the form of a plurality of granules.

7. A composition according to claim 6, wherein an average particle size of the plurality of granules is in the range of about 0.4 mm to about 3.5 mm.

8. A composition according to claim 1, wherein the extruded material has a density in the range of about 0.4 gcm⁻³ to about 1.5 gcm⁻³.

9. A composition according to claim 1, further comprising one or more tobacco-derived components.

10. A composition according to claim 9, wherein the one or more tobacco-derived components are provided in a second extruded material, wherein the extruded material and the second extruded material are in the form of granules which have been mixed.

11. An aerosol generating article, the article comprising a composition according to claim 1, wherein the article is configured to generate an inhalable medium as the composition is heated without burning.

12. An aerosol generating article according to claim 11, wherein the article is a cartridge for use in a device for generating an inhalable medium, the cartridge comprising a volatilizable liquid in a container, and the composition in a separate chamber.

13. An aerosol generating assembly for generating an inhalable medium, wherein the assembly comprises an article according to claim 11, and a heat source which is configured to heat, but not burn, the composition.

14. An aerosol generating device for generating an inhalable medium, the device comprising:
a container for holding a liquid;
a heater for volatilising a liquid held in the container;
a chamber containing a composition comprising an extruded material, wherein the extruded material comprises a flavorant and no tobacco-derived components according to claim 1; and
an outlet;
wherein the device is configured such that in use, an inhalable medium passes out of the outlet, the inhalable medium comprising (i) volatilized liquid in the form of a vapor and/or an aerosol, and (ii) one or more constituents of the composition retained in the chamber.

15. A device according to claim 14, wherein the device is configured such that in use, liquid volatilized by the heater passes, in the form of at least one of a vapor and an aerosol, through the chamber to thereby entrain one or more constituents from the composition retained therein to produce the inhalable medium which passes out of the outlet.

16. A method of preparing a composition comprising an extruded material, wherein the extruded material comprises a flavorant and no tobacco-derived components, the method comprising:
forming a mixture comprising the flavorant;
extruding the mixture; and
drying the extruded mixture to form the extruded material.

17. A kit comprising:
(i) a liquid pod containing a volatilizable liquid; and
(ii) a solid composition pod, containing a composition comprising an extruded material, wherein the extruded material comprises a flavorant and no tobacco-derived components;
wherein the liquid pod and the solid composition pod are configured for use in a device for use in generating an inhalable medium, the device being such that in use, an inhalable medium is generated, the medium comprising (i) volatilized liquid from the liquid pod in the form of a vapor and/or an aerosol and (ii) one or more constituents of the composition.

18. An aerosol generating assembly for generating an inhalable medium, wherein the assembly comprises an article according to claim 12, and a heat source which is configured to heat, but not burn, the composition.

19. A composition according to claim 1, further comprising nicotine.

20. A composition according to claim 1, wherein the extruded material comprises no nicotine.
